(19) United States
(12) Patent Application Publication
(10) Pub. No.: US 2016/0027388 A1
(43) Pub. Date: Jan. 28, 2016

(54) METHOD OF OPERATING DISPLAY DEVICE AND DISPLAY DEVICE PERFORMING THE SAME

(71) Applicant: Samsung Display Co., Ltd., Yongin-City (KR)

(72) Inventors: Young-Jun SEO, Seoul (KR); Jae-Joong KWON, Suwon-si (KR); Hyo-Sun KIM, Seongnam-si (KR); Byung-Choon YANG, Seoul (KR)

(21) Appl. No.: 14/573,987

(22) Filed: Dec. 17, 2014

(30) Foreign Application Priority Data
Jul. 23, 2014 (KR) 10-2014-0092943

(51) Int. Cl. G09G 3/34

(52) U.S. Cl. CPC G09G 3/3413

(57) ABSTRACT

A method of operating a display device is proposed. In the method, an input gray data is received, a luminance of external light is measured, the input gray data is converted into a linear gray data that is linearly proportional to a lightness obtained from a sum of a luminance of the display device and the luminance of the external light, and a display panel is driven by the use of the linear gray data.

### CROSS-REFERENCE TO RELATED APPLICATION(S)

This application claims priority under 35 USC §119 to Korean Patent Applications No. 10-2014-0092943, filed on Jul. 23, 2014 in the Korean Intellectual Property Office (KIPO), the contents of which are incorporated herein in its entirety by reference.

### BACKGROUND

1. Technical Field

Example embodiments relate generally to display devices. More particularly, embodiments of the inventive concept relate to methods of operating display devices and display devices performing the operation of the method.

2. Description of the Related Art

A display device is a device that displays an image based on input gray data. Examples of the display device include an organic light emitting diode (OLED) display device, a liquid crystal display (LCD) device, a field emission display (FED) device, a plasma display panel (PDP), etc. Recently, as a portable electronic device has been widely used, a display device in the portable electronic device may be often viewed in an environment where external light or ambient light exists. In this case, the visibility of the display device of the portable electronic device may deteriorate by the external light. Further, in case of a transparent display device capable of transmitting external light incident on the back side through the transparent display device to the front side, the visibility of the transparent display device may deteriorate by the external light passing through the transparent display device when the transparent display device displays an image on the front side.

### SUMMARY

Some example embodiments provide a method of operating a display device capable of improving visibility of the display device.

Some example embodiments provide a display device having improved visibility.

According to some example embodiments, there is provided a method of operating a display device. In the method, an input gray data is received, a luminance of external light is measured, the input gray data is converted into a linear gray data that is linearly proportional to a lightness obtained from a sum of a luminance of the display device and the luminance of the external light, and a display panel is driven by use of the linear gray data.

In example embodiments, to convert the input gray data into the linear gray data, a target lightness corresponding to the input gray data may be selected in a range between a maximum lightness and a lightness obtained from the luminance of the external light, based on a ratio of the input gray data to a maximum gray data, and the linear gray data may be extracted from a curve of the lightness obtained from the sum of the luminance of the display device and the luminance of the external light according to the input gray data based on the target lightness.

In example embodiments, the target lightness may be calculated by using an equation: Lt=(Lmax−Lam)*Di/Dmax+Lam, where Lt represents the target lightness, Lmax represents the maximum lightness, Di represents the input gray data, Dmax represents the maximum gray data, and Lam represents the lightness obtained from the luminance of the external light.

In example embodiments, to extract the linear gray data based on the target lightness, a target luminance may be calculated based on the target lightness, and the linear gray data may be calculated based on the target luminance.

In example embodiments, the target luminance may be calculated by using an equation:

$$Yt = \{ \begin{matrix}{( ( Lt + 16 ) / 116 )}^{3} & if ( Lt + 16 ) / 116 > 6 / 29 \\ 3 * {( 6 / 29 )}^{2} * ( \begin{matrix}( Lt + 16 ) / \\ 116 - 4 / 29\end{matrix} ) & if ( Lt + 16 ) / 116 \leq 6 / 29\end{matrix} ,$$

where Yt represents the target luminance, and Lt represents the target lightness.

In example embodiments, the linear gray data may be calculated by using an equation: D1=Dmax*(Yt/Ymax)̂(1/γ), where D1 represents the linear gray data, Dmax represents the maximum gray data, Yt represents the target luminance, Ymax represents a maximum luminance of the display device, and γ represents a gamma value of the display device.

In example embodiments, to convert the input gray data into the linear gray data, the linear gray data may be read from a look-up table that stores the linear gray data corresponding to the input gray data with respect to each value of the luminance of the external light, and the input gray data may be converted into the read linear gray data.

In example embodiments, the display device may be a transparent display device, and the external light may be transmitted light that passes through the transparent display device.

In example embodiments, to measure the luminance of the external light, a luminance of light incident on a surface opposite to a surface on which an image is displayed may be measured, and a luminance of the transmitted light may be calculated by multiplying the luminance of the incident light by a transmittance of the transparent display device.

According to some example embodiments, there is provided a method of operating a display device. In the method, an input gray data is received, a luminance of external light is measured, a target lightness based on the input gray data is selected in a range between a maximum lightness and a lightness obtained from the luminance of the external light, based on a ratio of the input gray data to a maximum gray data, a linear gray data is extracted from a curve of a lightness obtained from a sum of a luminance of the display device and the luminance of the external light according to the input gray data based on the target lightness, and a display panel is driven by the use of the linear gray data.

According to some example embodiments, there is provided a display device including a display panel, a light sensor to measure a luminance of external light, a data converting unit to receive an input gray data, and to convert the input gray data into a linear gray data that is linear with respect to a lightness obtained from a sum of a luminance of the display device and the luminance of the external light, and a driving unit to drive the display panel by the use of the linear gray data.

In example embodiments, the data converting unit may include a target lightness calculating unit to select a target lightness corresponding to the input gray data in a range between a maximum lightness and a lightness obtained from the luminance of the external light, based on a ratio of the input gray data to a maximum gray data, and a linear gray data calculating unit configured to extract the linear gray data from a curve of the lightness obtained from the sum of the luminance of the display device and the luminance of the external light according to the input gray data based on the target lightness.

In example embodiments, the target lightness calculating unit may calculate the target lightness by using an equation, “Lt=(Lmax−Lam)*Di/Dmax+Lam”, where Lt represents the target lightness, Lmax represents the maximum lightness, Di represents the input gray data, Dmax represents the maximum gray data, and Lam represents the lightness obtained from the luminance of the external light.

In example embodiments, the linear gray data calculating unit may calculate a target luminance based on the target lightness, and calculates the linear gray data based on the target luminance.

In example embodiments, the linear gray data calculating unit may calculate the target luminance by using an equation:

$$Yt = \{ \begin{matrix}{( ( Lt + 16 ) / 116 )}^{3} & if ( Lt + 16 ) / 116 > 6 / 29 \\ 3 * {( 6 / 29 )}^{2} * ( \begin{matrix}( Lt + 16 ) / \\ 116 - 4 / 29\end{matrix} ) & if ( Lt + 16 ) / 116 \leq 6 / 29\end{matrix} ,$$

where Yt represents the target luminance, and Lt represents the target lightness.

In example embodiments, the linear gray data calculating unit may calculate the linear gray data by using an equation: D1=Dmax*(Yt/Ymax)̂(1/γ), where D1 represents the linear gray data, Dmax represents the maximum gray data, Yt represents the target luminance, Ymax represents a maximum luminance of the display device, and γ represents a gamma value of the display device.

In example embodiments, the data converting unit may include a look-up table configured to store the linear gray data corresponding to the input gray data with respect to each value of the luminance of the external light, and a linear gray data outputting unit configured to read the linear gray data corresponding to the input gray data from the look-up table, and to output the read linear gray data to the driving unit.

In example embodiments, the display device may be a transparent display device, and the external light may be transmitted light that passes through the transparent display device.

In example embodiments, the light sensor may measure a luminance of light incident on a surface opposite to a surface on which an image is displayed.

In example embodiments, the display device may further include a luminance calculating unit configured to receive the luminance of the incident light from the light sensor, and to calculate a luminance of the transmitted light by multiplying the luminance of the incident light by a transmittance of the transparent display device.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of operating a display device according to example embodiments.

FIG. 2A is a graph illustrating luminance of a display device according to input gray data when external light does not exist and when the external light exists.

FIG. 2B is a graph illustrating lightness (or brightness perceived by a user) of a display device according to input gray data when external light does not exist and when the external light exists.

FIG. 2C is a graph illustrating lightness of a display device according to linear gray data when external light exists.

FIG. 2D is a graph illustrating lightness of a display device that is rescaled from the lightness of the display device illustrated in FIG. 2C based on luminance of external light.

FIG. 3 is a block diagram illustrating a display device according to example embodiments.

FIG. 4 is a flowchart illustrating a method of operating a display device according to example embodiments.

FIG. 5 is a graph for describing a method of generating linear gray data corresponding to input gray data in the method of FIG. 4.

FIG. 6 is a block diagram illustrating a display device according to example embodiments.

FIG. 7 is a flowchart illustrating a method of operating a display device according to example embodiments.

FIG. 8 is a graph for describing a method of generating linear gray data corresponding to input gray data in the method of FIG. 7.

FIG. 9 is a diagram illustrating a display device according to example embodiments.

FIG. 10 is a block diagram illustrating a display device according to example embodiments.

FIG. 11 is a block diagram illustrating an electronic device including a display device according to example embodiments.

### DESCRIPTION OF EMBODIMENTS

The example embodiments are described more fully hereinafter with reference to the accompanying drawings. Like or similar reference numerals refer to like or similar elements throughout.

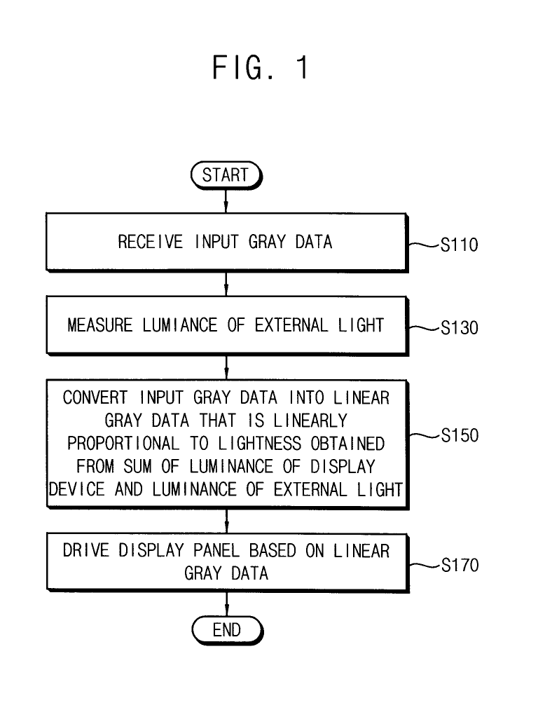

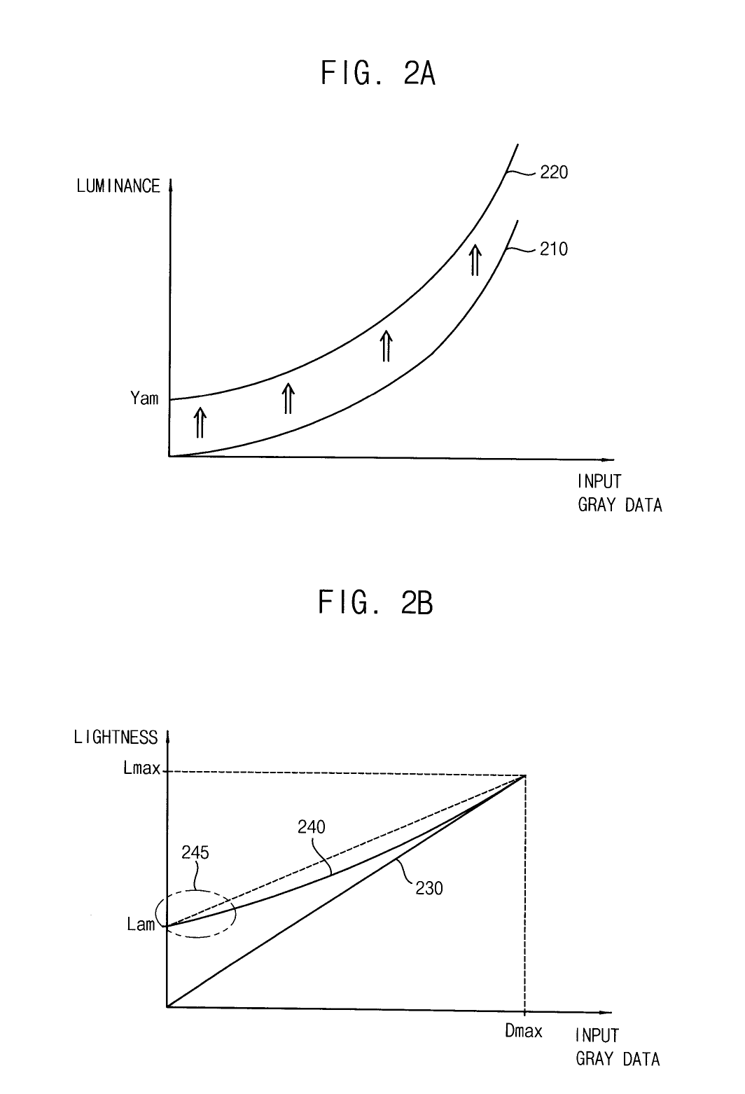

FIG. 1 is a flowchart illustrating a method of operating a display device according to example embodiments, FIG. 2A is a graph illustrating luminance of a display device according to input gray data when external light does not exist and when the external light exists, FIG. 2B is a graph illustrating lightness (or brightness perceived by a user) of a display device according to input gray data when external light does not exist and when the external light exists, FIG. 2C is a graph illustrating lightness of a display device according to linear gray data when external light exists, and FIG. 2D is a graph illustrating lightness of a display device that is rescaled from the lightness of the display device illustrated in FIG. 2C based on luminance of external light.

Referring to FIG. 1, a display device may receive an input gray data from an external device, such as a graphic processing unit (GPU) or a graphic card (S110). In some example embodiments, the display device may be an organic light emitting diode (OLED) display device, a liquid crystal display (LCD) device, a field emission display (FED) device, a plasma display panel (PDP), or the like.

The display device may measure a luminance of external light (or ambient light) by using a sensor (S130). For example, the sensor may be a photo sensor or a luminance sensor. According to example embodiments, the photo sensor or the luminance sensor may measure the luminance of the external light, or may measure a color coordinate of the external light as well as the luminance of the external light. In some example embodiments, the sensor may be formed inside the display device. For example, the sensor may be formed at an active region of a display panel, may be formed at a peripheral region of the display panel, or may be formed at a printed circuit board connected to the display panel. In other example embodiments, the sensor may be formed outside the display device, for example in an electronic device including the display device.

The display device may convert the input gray data into a linear gray data that is linearly proportional to a lightness obtained from a sum of a luminance of the display device and the luminance of the external light (S150). In some example embodiments, in converting the input gray data into the linear gray data, not only the luminance of the external light but also the color coordinate of the external light may be further considered. Here, the linear gray data may be a gray data that is linearly mapped to the lightness (or brightness perceived by a viewer) obtained from the sum of the luminance of the display device and the luminance of the external light, or to the lightness of the display device in an environment where the external light exists (or brightness of the display device perceived by a viewer in the environment where the external light exists). Further, the mapping of the gray data may be referred to as “Lightness Linear Mapping.” The display device may drive the display panel based on the linear gray data. If the display panel is driven based on the linear gray data that is linear to the lightness obtained from the sum of the luminance of the display device and the luminance of the external light, or to the lightness of the display device in the environment where the external light exists, the lightness, or the brightness perceived by the viewer in the environment, where the external light exists, may linearly increase as a gray value of the input gray data increases.

In FIG. 2A, the curve 210 represents the luminance of the display device, which increases with the value of the input gray data. Herein, the gray data means gray level. If the gray level is 8 bits, the maximum value of the input gray data is 255. The curve 210 may be the case when no external light exists. When external light exists by the amount of an external luminance Yam, the actual luminance of the display device would increase by the external luminance Yam. The curve 220 represents the actual luminance of the display device, which is the sum of the luminance 210 of display device and the external luminance Yam. As illustrated in FIG. 2A, the luminance 210 of the display device according to the input gray data may be increased by the luminance Yam of the external light in the environment where the external light exists. That is, the luminance 210 of the display device according to the input gray data may be increased to a sum 220 of the luminance 210 of the display device and the luminance Yam of the external light. As illustrated in FIG. 2B, a lightness 230 of the display device, in an environment where the external light does not exist, may be substantially linear to the input gray data. However, the actual lightness 240 of the display device in the environment where the external light exists, or the lightness 240 obtained from the sum 220 of the luminance 210 of the display device and the luminance Yam of the external light may not be linearly proportional to the input gray data. In particular, at a low gray region 245, as illustrated in FIG. 2B, the lightness 240 obtained from the sum 220 of the luminance 210 of the display device and the luminance Yam of the external light may scarcely increase although the gray value of the input data increases, which results in agglomeration of the gray values.

To prevent this gray value agglomeration, and to improve the visibility of the display device in the environment where the external light exists, the display device according to example embodiments may convert the input gray data into the linear gray data that is linearly mapped to the actual lightness 240 obtained from the sum 220 of the luminance 210 of the display device and the luminance Yam of the external light. As illustrated in FIG. 2C, the lightness 250 obtained from the sum 220 of the luminance 210 of the display device and the luminance Yam of the external light based on the linear gray data may be linear to the linear gray data. For example, the lightness 250 of the display device according to the linear gray data, in the environment where the external light exists, may be represented as a straight line from a point, at which the linear gray data is 0 and the lightness is a lightness Lam obtained from the luminance Yam of the external light, to a point where the value of the linear gray data is the maximum gray data Dmax and the lightness is the maximum lightness Lmax (e.g., a value of 100). In FIG. 2C, since an X-axis of FIG. 2C represents the linear gray data that is linearly mapped to the lightness of the display device in the environment where the external light exists, data points (or scale) of the X-axis of FIG. 2C may not be linearly proportional to gray values of the input gray data. Here, the “lightness” may be brightness perceived by the viewer, and may represent relative brightness compared with the maximum lightness Lmax. For example, the maximum value of the lightness or the maximum lightness Lmax (e.g., lightness of a white color) may be 100, and the minimum value of the lightness or the minimum lightness (e.g., lightness of a black color) may be 0. Thus, when the lightness 250 of the display device according to the linear gray data in the environment where the external light exists is expressed with the lightness Lam by the external light as a based point (or the minimum lightness), the lightness 250 of the display device according to the linear gray data in the environment where the external light exists may be a straight line 250′ as illustrated in FIG. 2D.

As described above, in the method of operating the display device according to example embodiments, the luminance of the external light may be measured, and an image may be displayed based on the linear gray data that is linear with respect to the lightness where the luminance of the external light is reflected, thereby improving the visibility of the display device in the environment where the external light exists. That is, the method of operating the display device according to example embodiments may enhance not a mere contrast ratio according to the luminance of the display device, but a cognitive contrast ratio according to the lightness, or the brightness perceived by the viewer, and thus the visibility of the display device may be improved even in the environment where the external light exists.

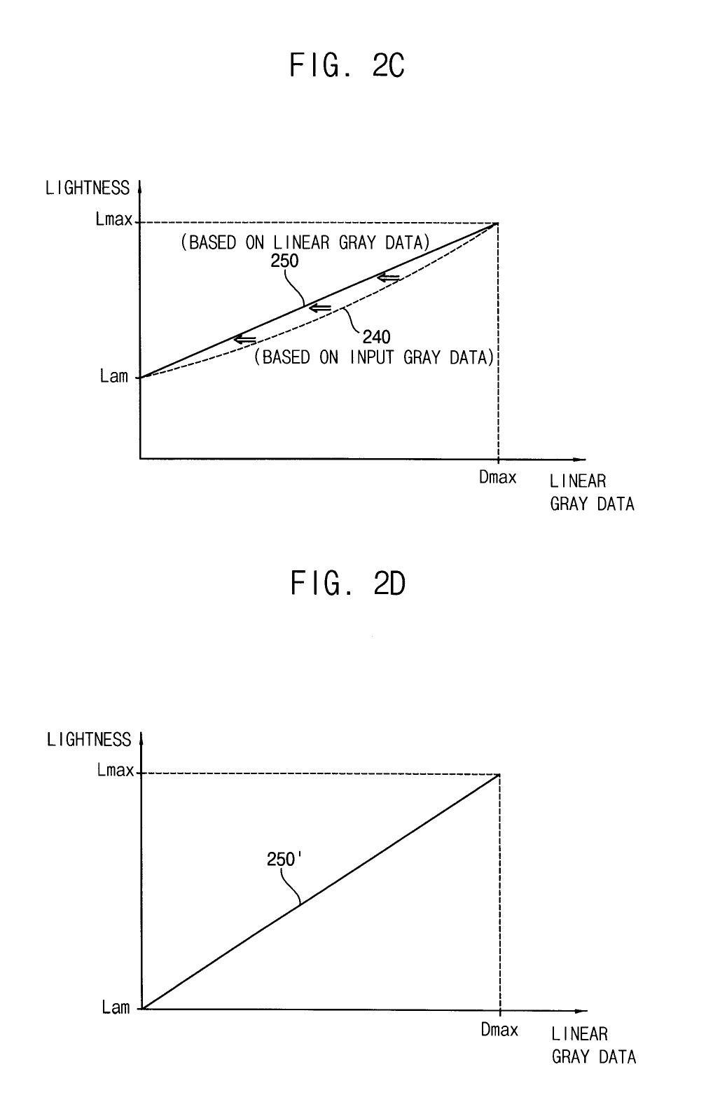

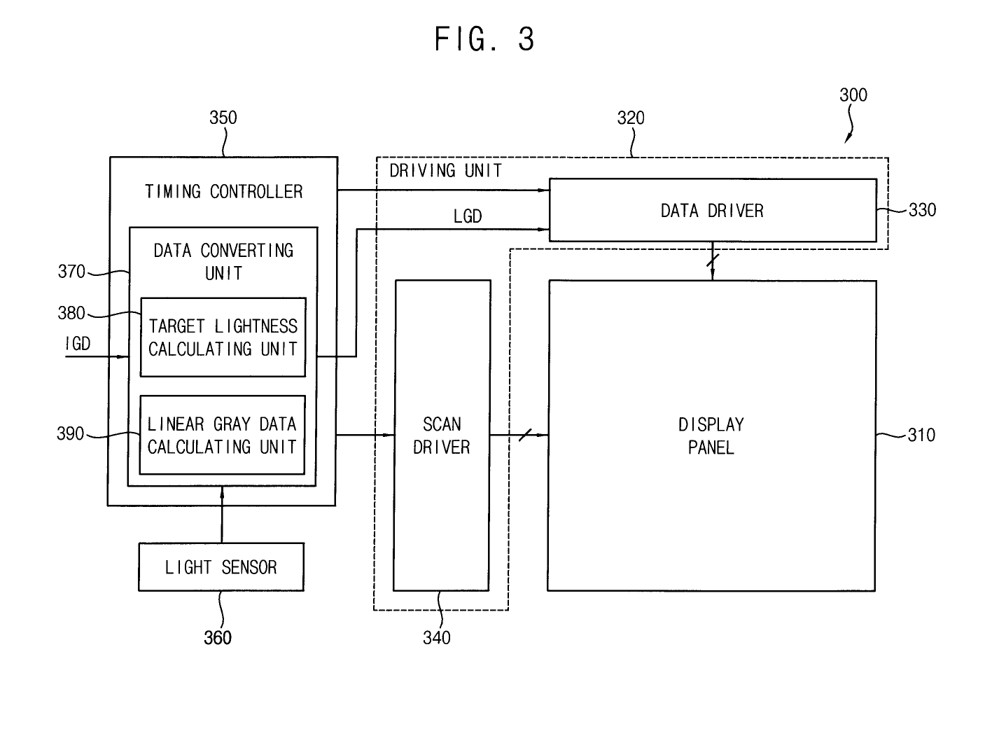

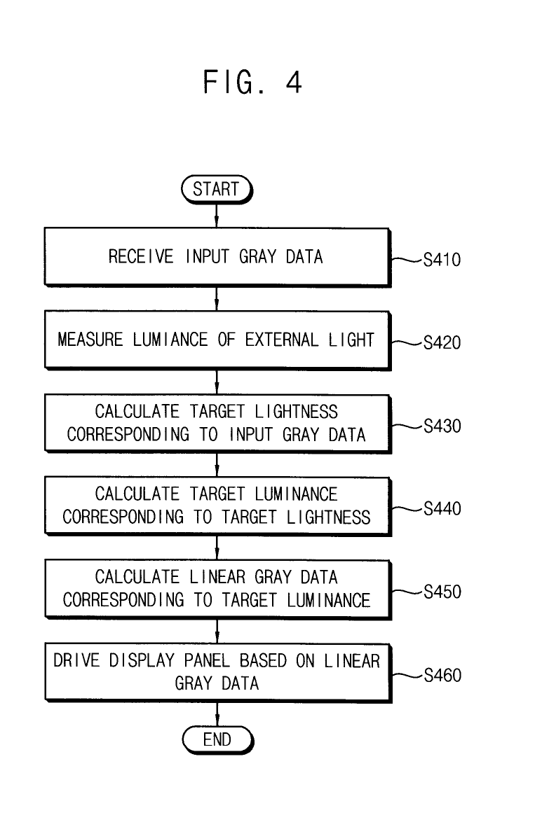

FIG. 3 is a block diagram illustrating a display device according to example embodiments, FIG. 4 is a flowchart illustrating a method of operating a display device according to example embodiments, and FIG. 5 is a graph for describing a method of generating linear gray data corresponding to input gray data in the method of FIG. 4.

Referring to FIG. 3, a display device 300 includes a display panel 310, a driving unit 320 that drives the display panel 310, a timing controller 350, a light sensor 360 and a data converting unit 370.

The display panel 310 may be coupled to a data driver 320 included in the driving unit 320 through a plurality of data lines, and may be coupled to a scan driver included in the driving unit 320 through a plurality of scan lines. In some example embodiments, the display panel 310 may be an OLED panel, an LCD panel, a FED panel, a PDP panel, or the like.

The driving unit 320 may include the data driver 330 and the scan driver 340. The data driver 330 may apply a data signal (e.g., an electronic signal corresponding to a linear gray data) to the display panel 310 through the plurality of data lines, and the scan driver 340 may apply a scan signal to the display panel 310 through the plurality of scan lines.

The timing controller 350 may control an operation of the display device 300. For example, the timing controller 350 may provide predetermined control signals to the data driver 330 and the scan driver 340 to control the operation of the display device 300. In some example embodiments, the data driver 330, the scan driver 340 and the timing controller 350 may be implemented as one integrated circuit (IC). In other example embodiments, the data driver 330, the scan driver 340 and the timing controller 350 may be implemented as two or more integrated circuits.

The light sensor 360 may measure a luminance of external light. According to example embodiments, the light sensor 360 may be formed at an active region of the display panel 310, may be formed at a peripheral region of the display panel 310, or may be formed at a printed circuit board connected to the display panel 310. Although FIG. 3 illustrates an example where the light sensor 360 is included in the display device 300, in some example embodiments, the light sensor 360 may be implemented as a separate device.

In some example embodiments, the data converting unit 370 may include a target lightness calculating unit 380 and a linear gray data calculating unit 390. The target lightness calculating unit 380 may select a target lightness corresponding to input gray data IGD in a range from a lightness by the luminance of the external light to the maximum lightness based on a ratio of the input gray data IGD to the maximum gray data. The linear gray data calculating unit 390 may extract linear gray data LGD from a curve of a lightness obtained from a sum of a luminance of the display device 300 and the luminance of the external light according to the input gray data IGD based on the target lightness. Examples of operations of the target lightness calculating unit 380 and the linear gray data calculating unit 390 will be described below with reference to FIGS. 4 and 5.

Hereinafter, a method of operating the display device 300 according to example embodiments will be described below with reference to FIGS. 3 through 5.

Referring to FIGS. 3 through 5, the data converting unit 370 receives the input gray data IGD (S410). The light sensor 360 measures the luminance of the external light (S420).

As illustrated in FIG. 5, the target lightness calculating unit 380 selects the target lightness Lt, which corresponds to the input gray data Di, in a range between the maximum lightness Lmax and the lightness Lam, which is obtained from the luminance of the external light, based on the ratio of the input gray data Di to the maximum gray data Dmax. For example, the lightness Lam may be obtained from the luminance of the external light based on a conversion between lightness and luminance based on the standard of CIELAB, the standard of CIECAM02, or the like. Further, in a case where a gray data has 8 bits, the maximum gray data Dmax is 255. In some example embodiments, the target lightness calculating unit 380 may calculate the target lightness Lt corresponding to the input gray data Di by using Equation 1 (S430).

Lt=(Lmax−Lam)*Di/Dmax+Lam Equation 1:

Here, Lt represents the target lightness, Lmax represents the maximum lightness, Di represents the input gray data, Dmax represents the maximum gray data, and Lam represents the lightness obtained from the luminance of the external light.

The target lightness Lt calculated by using Equation 1 may linearly increase as a gray value of the input gray data Di increases.

The linear gray data calculating unit 390 extracts the linear gray data D1 from the curve 510 of the lightness obtained from the sum of the luminance of the display device 300 and the luminance of the external light according to the input gray data Di based on the target lightness Lt. To achieve this, the linear gray data calculating unit 390 calculates a target luminance corresponding to the target lightness Lt (S440), and calculates the linear gray data D1 corresponding to the target luminance (S450). For example, the linear gray data calculating unit 390 may calculate the target luminance by using Equation 2.

$$Yt = \{ \begin{matrix}{( ( Lt + 16 ) / 116 )}^{3} & \begin{matrix}if ( Lt + 16 ) / \\ 116 > 6 / 29\end{matrix} \\ 3 * {( 6 / 29 )}^{2} * ( \begin{matrix}( Lt + 16 ) / \\ 116 - 4 / 29\end{matrix} ) & \begin{matrix}if ( Lt + 16 ) / \\ 116 \leq 6 / 29\end{matrix}\end{matrix} \qquad Equation 2$$

Here, Yt represents the target luminance, and Lt represents the target lightness.

Although Equation 2 is based on a conversion between lightness and luminance based on the standard of CIELAB, the conversion between lightness and luminance may not be limited thereto, and may be performed based on another standard, such as CIECAM02, or the like.

The linear gray data calculating unit 390 may calculate the linear gray data D1 by using Equation 3.

D1=Dmax*(Yt/Ymax)̂(1/γ) Equation 3:

Here, D1 represents the linear gray data, Dmax represents the maximum gray data, Yt represents the target luminance, Ymax represents a maximum luminance of the display device, and γ represents a gamma value of the display device.

The driving unit 320 may drive the display panel 310 based on the linear gray data D1 (S460). That is, when the display device 300 receives the input gray data Di, the display device 300 may drive the display panel 310 to display an image with a luminance corresponding not to the input gray data Di but to the linear gray data D1. The linear gray data D1 calculated as described above may be linear to the lightness 510 obtained from the sum of the luminance of the display device 300 and the luminance of the external light, or the lightness 510 of the display device 300 in an environment where the external light exists, and thus the display device 300 may display an image with lightness that linearly increases as a gray value of the input gray data Di increases. Accordingly, even in the environment where the external light exists, the visibility and the cognitive contrast ratio of the display device 300 may be improved.

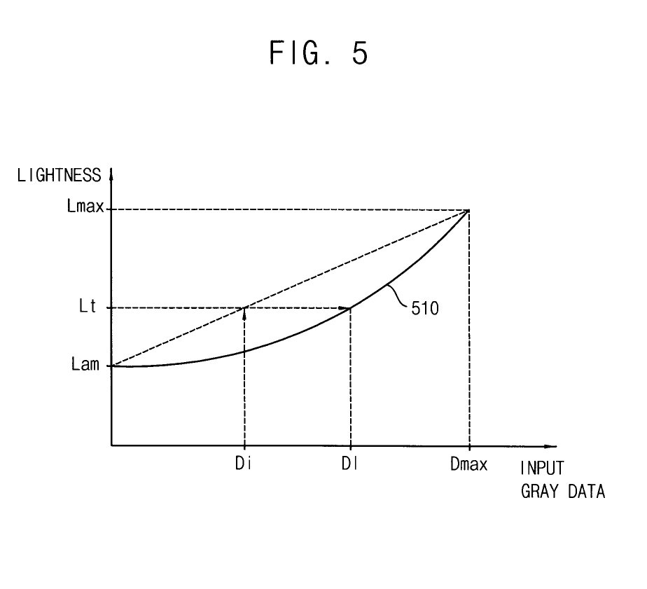

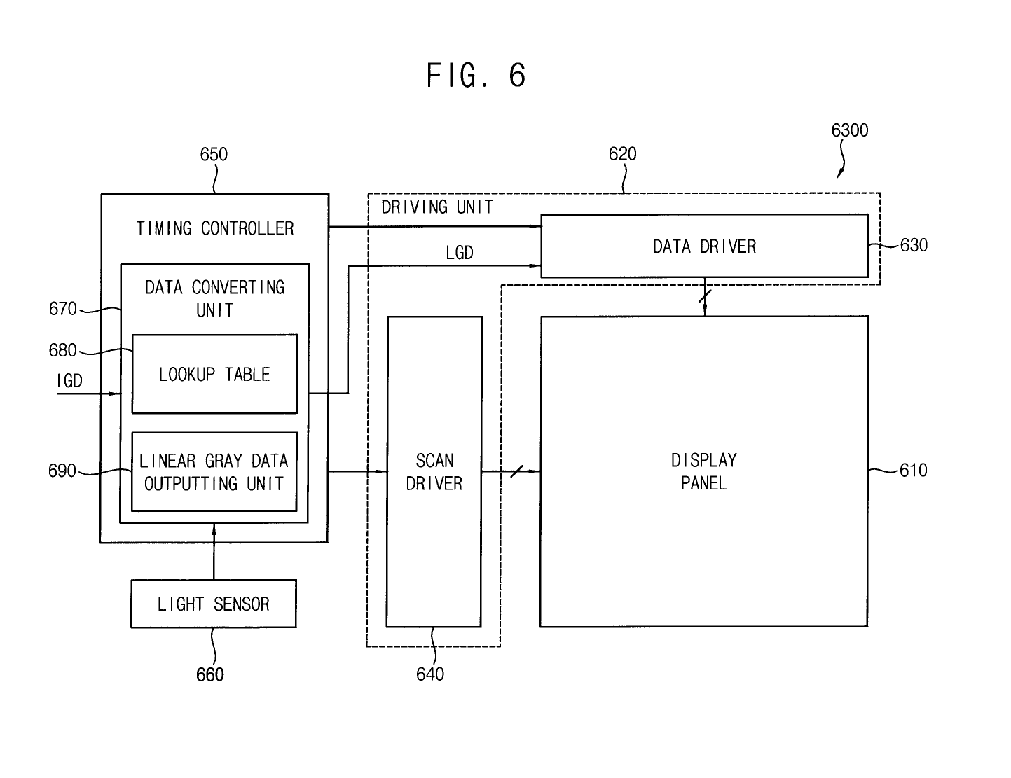

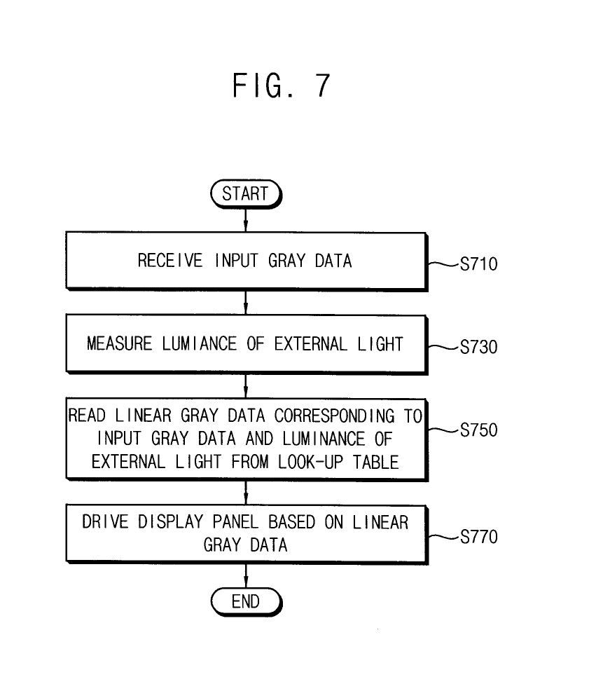

FIG. 6 is a block diagram illustrating a display device according to example embodiments, FIG. 7 is a flowchart illustrating a method of operating a display device according to example embodiments, and FIG. 8 is a graph for describing a method of generating linear gray data corresponding to input gray data in the method of FIG. 7.

Referring to FIG. 6, a display device 600 includes a display panel 610, a driving unit 620 including a data driver 630 and a scan driver 640, a timing controller 650, a light sensor 660 and a data converting unit 670. The display device 600 of FIG. 6 may have a similar configuration to a display device 300 of FIG. 3, except for a configuration of the data converting unit 670.

The data converting unit 670 may receive input gray data IGD from an external device, and may receive a luminance of external light measured by the light sensor 660. The data converting unit 670 may convert the input gray data IGD into a linear gray data LGD that is linear to a lightness obtained from a sum of a luminance of the display device 600 and the luminance of the external light.

In some example embodiments, the data converting unit 670 may include a look-up table 680 and a linear gray data outputting unit 690. The look-up table 680 may store the linear gray data LGD corresponding to the input gray data IGD with respect to each luminance of the external light. For example, a range of the luminance of the external light may be divided into a plurality of sub-ranges, and the look-up table 680 may store respective values of the linear gray data LGD corresponding to respective values of the input gray data IGD with respect to each sub-range of the luminance of the external light. The linear gray data outputting unit 690 may receive the luminance of the external light and the input gray data IGD, may read the linear gray data LGD corresponding to the input gray data IGD and the luminance of the external light from the look-up table 680, and may output the read linear gray data LGD to the driving unit 620.

Hereinafter, a method of operating the display device 600 according to example embodiments will be described below with reference to FIGS. 6 through 8.

Referring to FIGS. 6 through 8, the data converting unit 670 receives the input gray data IGD from an external device (S710). The light sensor 660 measures the luminance of the external light (S730).

The linear gray data LGD corresponding to the input gray data IGD with respect to each luminance of the external light may be previously stored in the look-up table 680 of the data converting unit 670. For example, as illustrated in FIG. 8, in a curve 810 of the lightness of the display device 600 with respect to each luminance of the external light, a range from the lightness Lam of the external light to the maximum lightness Lmax may be substantially equally divided by the number of values of the gray data (e.g., the number of values of the input gray data IGD), and values D1, D2, D3 and Dmax of the linear gray data LGD respectively corresponding to the respective divided luminances L1, L2, L3 and Lmax may be stored in the look-up table 680.

The linear gray data outputting unit 690 of the data converting unit 670 may read the linear gray data LGD corresponding to the luminance of the external light and the input gray data IGD from the look-up table 680, and may output the linear gray data LGD to the driving unit 620 (S750).

The driving unit 620 may drive the display panel 610 based on the linear gray data LGD (S770). That is, when the display device 600 receives the input gray data IGD, the display device 600 may drive the display panel 610 to display an image with a luminance corresponding not to the input gray data IGD but to the linear gray data LGD. The linear gray data LGD may be linear to the lightness obtained from the sum of the luminance of the display device 600 and the luminance of the external light, or the lightness of the display device 600 in the environment where the external light exists, and thus the display device 600 may display an image with lightness that linearly increases as a gray value of the input gray data IGD increases. Accordingly, even in the environment where the external light exists, the visibility and the cognitive contrast ratio of the display device 600 may be improved.

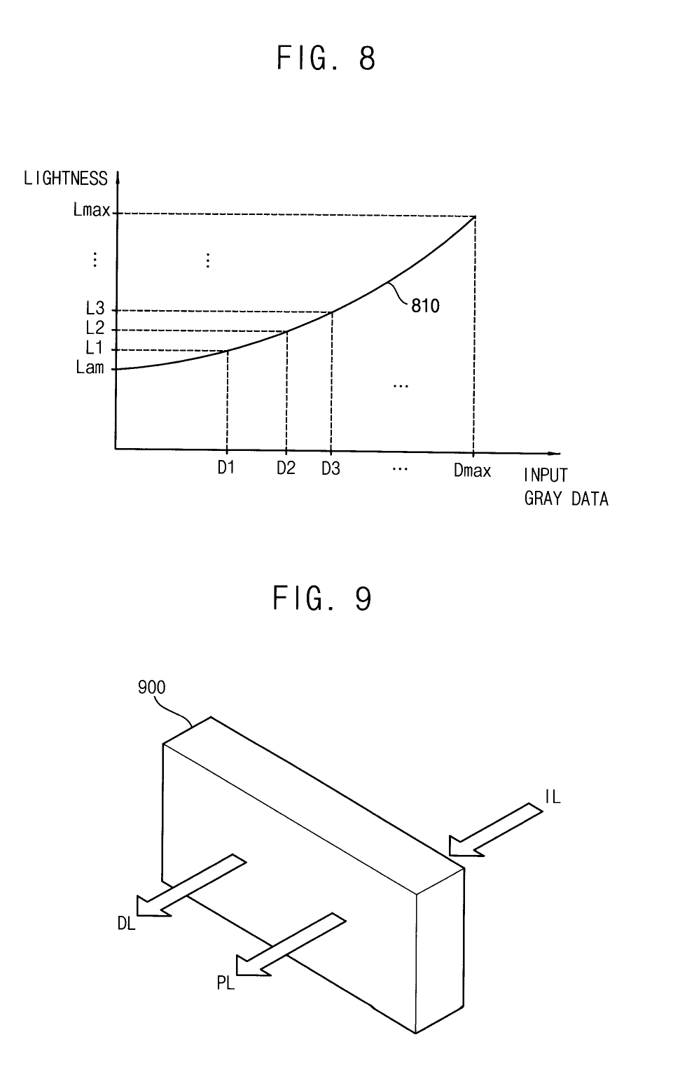

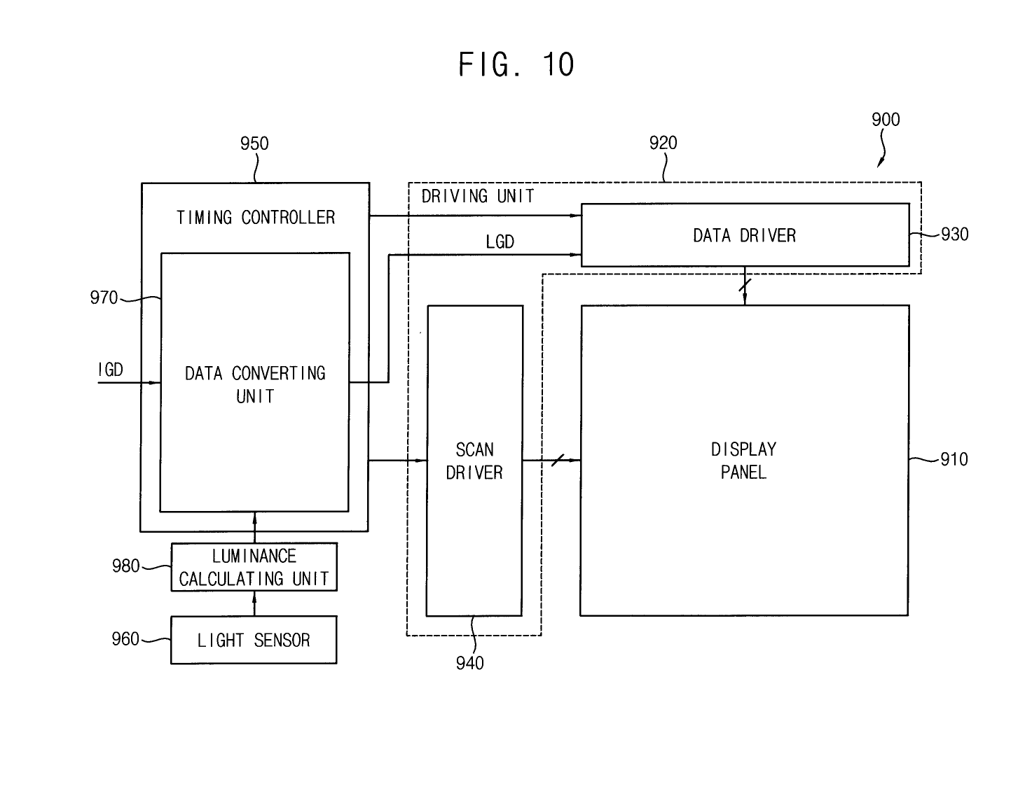

FIG. 9 is a diagram illustrating a display device according to example embodiments, and FIG. 10 is a block diagram illustrating a display device according to example embodiments.

Referring to FIGS. 9 and 10, a display device 900 may display an image by emitting light DL corresponding to the image, and may transmit, as transmitted light PL, external light IL incident on a surface opposite to a surface on which the image is displayed. That is, the display device 900 may be a transparent display device capable of transmitting the external light. The display device 900 may include a display panel 910, a driving unit 920 including a data driver 930 and a scan driver 940, a timing controller 950, a light sensor 960, a data converting unit 970 and a luminance calculating unit 980. Compared with a display device 300 of FIG. 3 and a display device 600 of FIG. 6, the display device 900 of FIGS. 9 and 10 may further include the luminance calculating unit 980.

In some example embodiments, the light sensor 960 may be formed on the surface opposite to the display surface to measure the luminance of the light IL incident on the opposite surface.

The luminance calculating unit 980 may receive the luminance of the incident light IL from the light sensor 960, and may calculate a luminance of the transmitted light PL by multiplying the luminance of the incident light IL by the transmittance of the transparent display device 900.

The data converting unit 970 may convert an input gray data IGD to a linear gray data LGD that is linear to a lightness obtained from a sum of the luminance of the display device 900 and the luminance of the transmitted light PL, and the driving unit 920 may drive the display panel 910 based on the linear gray data LGD.

As described above, the transparent display device 900 according to example embodiments, the image may be displayed based on the linear gray data LGD that is linear to the lightness where the luminance of the transmitted light PL is reflected, thereby improving the visibility and the cognitive contrast ratio of the transparent display device 900.

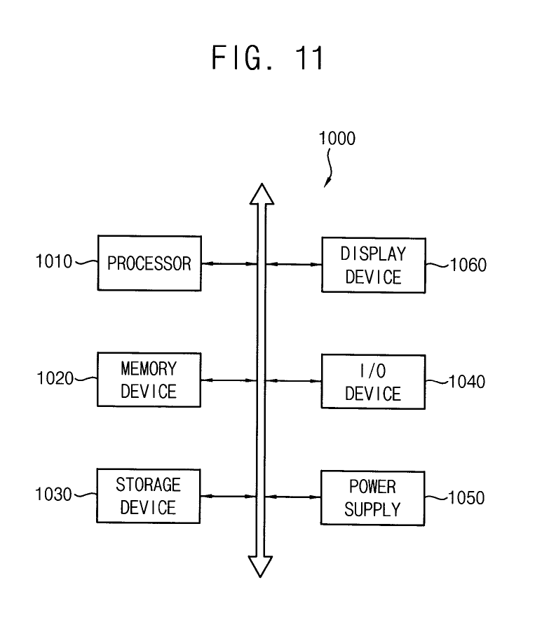

FIG. 11 is a block diagram illustrating an electronic device including a display device according to example embodiments.

Referring to FIG. 11, an electronic device 1000 may include a processor 1010, a memory device 1020, a storage device 1030, an input/output (I/O) device 1040, a power supply 1050, and a display device 1060. The electronic device 1000 may further include a plurality of ports for communicating a video card, a sound card, a memory card, a universal serial bus (USB) device, other electric devices, etc.

The processor 1010 may perform various computing functions. The processor 1010 may be a micro processor, a central processing unit (CPU), etc. The processor 1010 may be coupled to other components via an address bus, a control bus, a data bus, etc. Further, in some example embodiments, the processor 1010 may be coupled to an extended bus such as a peripheral component interconnection (PCI) bus.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc.

The storage device 1030 may be a solid state drive device, a hard disk drive device, a CD-ROM device, etc. The I/O device 1040 may be an input device such as a keyboard, a keypad, a mouse, a touch screen, etc, and an output device such as a printer, a speaker, etc. The power supply 1050 may supply power for operations of the electronic device 1000. The display device 1060 may communicate with other components via the buses or other communication links.

The display device 1060 may display an image based on a linear gray data that is linear to a lightness where a luminance of external light is reflected, thereby improving the visibility and the cognitive contrast ratio of the display device 1060 in an environment where the external light exists. In some example embodiments, the display device 1060 may be a transparent display device, and an image may be displayed based on a linear gray data that is linear to a lightness where a luminance of transmitted light is reflected, thereby improving the visibility and the cognitive contrast ratio of the transparent display device.

The present inventive concept may be applied to any electronic device 1000 including the display device 1060. For example, the present inventive concept may be applied to a television, a computer monitor, a laptop, a digital camera, a cellular phone, a smart phone, a personal digital assistant (PDA), a portable multimedia player (PMP), a MP3 player, a navigation system, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of operating a display device, the method comprising:
receiving an input gray data;
measuring a luminance of external light;
converting the input gray data into a linear gray data that is linearly proportional to a lightness that is obtained from a sum of a luminance of the display device and the luminance of the external light; and
driving a display panel by use of the linear gray data.

2. The method of claim 1, wherein converting the input gray data into the linear gray data comprises:
selecting a target lightness based on the input gray data in a range between a maximum lightness and a lightness obtained from the luminance of the external light, based on a ratio of the input gray data to a maximum gray data; and
extracting the linear gray data from a curve of the lightness obtained from the sum of the luminance of the display device and the luminance of the external light according to the input gray data based on the target lightness.

3. The method of claim 2, wherein the target lightness is calculated by using an equation:
Lt=(Lmax−Lam)*Di/Dmax+Lam
where Lt represents the target lightness, Lmax represents the maximum lightness, Di represents the input gray data, Dmax represents the maximum gray data, and Lam represents the lightness obtained from the luminance of the external light.

4. The method of claim 2, wherein extracting the linear gray data based on the target lightness comprises:
calculating a target luminance based on the target lightness; and
calculating the linear gray data based on the target luminance.

5. The method of claim 4, wherein the target luminance is calculated by using an equation:
$$Yt = \{ \begin{matrix}{( ( Lt + 16 ) / 116 )}^{3} & if ( Lt + 16 ) / 116 > 6 / 29 \\ 3 * {( 6 / 29 )}^{2} * ( \begin{matrix}( Lt + 16 ) / \\ 116 - 4 / 29\end{matrix} ) & if ( Lt + 16 ) / 116 \leq 6 / 29\end{matrix}$$
where Yt represents the target luminance, and Lt represents the target lightness.

6. The method of claim 4, wherein the linear gray data is calculated by using an equation:
D1=Dmax*(Yt/Ymax)̂(1/γ)
where D1 represents the linear gray data, Dmax represents the maximum gray data, Yt represents the target luminance, Ymax represents a maximum luminance of the display device, and γ represents a gamma value of the display device.

7. The method of claim 1, wherein converting the input gray data into the linear gray data comprises:
reading the linear gray data from a look-up table that stores the linear gray data corresponding to the input gray data with respect to each value of the luminance of the external light; and
converting the input gray data into the read linear gray data.

8. The method of claim 1, wherein the display device is a transparent display device, and the external light is transmitted light that passes through the transparent display device.

9. The method of claim 8, wherein measuring the luminance of the external light includes:
measuring a luminance of light incident on a surface opposite to a surface on which an image is displayed; and
calculating a luminance of the transmitted light by multiplying the luminance of the incident light by a transmittance of the transparent display device.

10. A method of operating a display device, the method comprising:
receiving an input gray data;
measuring a luminance of external light;
selecting a target lightness based on the input gray data in a range between a maximum lightness and a lightness obtained from the luminance of the external light, based on a ratio of the input gray data to a maximum gray data;
extracting a linear gray data from a curve of a lightness obtained from a sum of a luminance of the display device and the luminance of the external light according to the input gray data based on the target lightness; and
driving a display panel by use of the linear gray data.

11. A display device, comprising:
a display panel;
a light sensor to measure a luminance of external light;
a data converting unit to receive an input gray data, and to convert the input gray data into a linear gray data that is linear with respect to a lightness obtained from a sum of a luminance of the display device and the luminance of the external light; and
a driving unit to drive the display panel by use of the linear gray data.

12. The display device of claim 11, wherein the data converting unit comprises:
a target lightness calculating unit to select a target lightness corresponding to the input gray data in a range between a maximum lightness and a lightness obtained from the luminance of the external light, based on a ratio of the input gray data to a maximum gray data; and
a linear gray data calculating unit to extract the linear gray data from a curve of the lightness obtained from the sum of the luminance of the display device and the luminance of the external light according to the input gray data based on the target lightness.

13. The display device of claim 12, wherein the target lightness calculating unit calculates the target lightness by using an equation:
Lt=(Lmax−Lam)*Di/Dmax+Lam
where Lt represents the target lightness, Lmax represents the maximum lightness, Di represents the input gray data, Dmax represents the maximum gray data, and Lam represents the lightness obtained from the luminance of the external light.

14. The display device of claim 12, wherein the linear gray data calculating unit calculates a target luminance based on the target lightness, and calculates the linear gray data based on the target luminance.

15. The display device of claim 14, wherein the linear gray data calculating unit calculates the target luminance by using an equation:
$$Yt = \{ \begin{matrix}{( ( Lt + 16 ) / 116 )}^{3} & if ( Lt + 16 ) / 116 > 6 / 29 \\ 3 * {( 6 / 29 )}^{2} * ( \begin{matrix}( Lt + 16 ) / \\ 116 - 4 / 29\end{matrix} ) & if ( Lt + 16 ) / 116 \leq 6 / 29\end{matrix}$$
where Yt represents the target luminance, and Lt represents the target lightness.

16. The display device of claim 14, wherein the linear gray data calculating unit calculates the linear gray data by using an equation:
D1=Dmax*(Yt/Ymax)̂(1/γ)
where D1 represents the linear gray data, Dmax represents the maximum gray data, Yt represents the target luminance, Ymax represents a maximum luminance of the display device, and γ represents a gamma value of the display device.

17. The display device of claim 11, wherein the data converting unit comprises:
a look-up table to store the linear gray data corresponding to the input gray data with respect to each value of the luminance of the external light; and
a linear gray data outputting unit to read the linear gray data corresponding to the input gray data from the look-up table, and to output the read linear gray data to the driving unit.

18. The display device of claim 11, wherein the display device is a transparent display device, and the external light is transmitted light that passes through the transparent display device.

19. The display device of claim 18, wherein the light sensor measures a luminance of light incident on a surface opposite to a surface on which an image is displayed.

20. The display device of claim 19, further comprising:
a luminance calculating unit to receive the luminance of the incident light from the light sensor, and to calculate a luminance of the transmitted light by multiplying the luminance of the incident light by a transmittance of the transparent display device.
